(19) United States
(12) Patent Application Publication
(10) Pub. No.: US 2012/0078651 A1
(43) Pub. Date: Mar. 29, 2012

(54) METHOD AND APPARATUS FOR THE COMPARISON OF HEALTH CARE PROCEDURE COSTS BETWEEN PROVIDERS

(75) Inventors: Christopher Henderson, Penacook, NH (US); Stephen Baines, Goffstown, NH (US); Robert Graybill, Amherst, NH (US)

(73) Assignee: COMPASS HEALTHCARE ADVISERS, Bedford, NH (US)

(21) Appl. No.: 13/246,060

(22) Filed: Sep. 27, 2011

Related U.S. Application Data
(60) Provisional application No. 61/386,712, filed on Sep. 27, 2010.

(51) Int. Cl. G06Q 50/00

(52) U.S. Cl. 705/2

(57) ABSTRACT

A method is provided for the ranking of health care providers, the method comprising: identification of a user and logging of the user into a database having user information stored therein; entering of additional user demographic information necessary for a comparison of health care provider services; selecting a desired medical procedure for comparison between providers; presenting to the user of a facility ranking for the desired medical procedure based upon quality and cost; storage of ranking information for future retrieval by the user; and forwarding the ranking information to an insurance carrier to which the user subscribes.

### RELATED APPLICATIONS

This application claims the benefit of U.S. Provisional Applications No. 61/386,712, filed Sep. 27, 2010. This application is herein incorporated by reference in their entirety for all purposes.

### FIELD OF THE INVENTION

The invention relates to cost comparison tools, and more particularly, to a cost comparison tool configured to help users understand the cost variation by procedure that exists within a healthcare system.

### BACKGROUND OF THE INVENTION

Today the normal economics forces don't exist within our Healthcare field. Consumers of healthcare lack the information, knowledge and tools to perform basic cost comparisons when contemplating having a medical procedure.

Currently, medical cost comparison information is based upon a simplistic build up of the various costs associated with the procedure. Known systems fail to capture all of the specific cost elements delivered during the procedure and presents the consumer with an “apples” to “apples” cost comparison across various facilities for the particular procedure requested.

What is needed, therefore, are techniques for providing consumers (patients) with supporting data in order to compare cost for like procedures within a geographical area.

### SUMMARY OF THE INVENTION

One embodiment of the present invention provides a method for the ranking of health care providers, the method comprising: identification of a user and logging of the user into a database having user information stored therein; entering of additional user demographic information necessary for a comparison of health care provider services; selecting a desired medical procedure for comparison between providers; presenting to the user of a facility ranking for the desired medical procedure based upon quality and cost; storage of ranking information for future retrieval by the user; and forwarding the ranking information to an insurance carrier to which the user subscribes.

Another embodiment of the present invention provides such a method further comprising, emailing the ranking information to the user.

A further embodiment of the present invention provides such a method further comprising confirming an incentive list provided by the insurance carrier.

Still another embodiment of the present invention provides such a method further comprising issuing an incentive to the user for using the method.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a flow chart illustrating the process flow of a system configured in accordance with one embodiment of the present invention.

FIG. 1B is a continuation of the flow chart of FIG. 1A illustrating the process flow of a system configured in accordance with one embodiment of the present invention.

### DETAILED DESCRIPTION

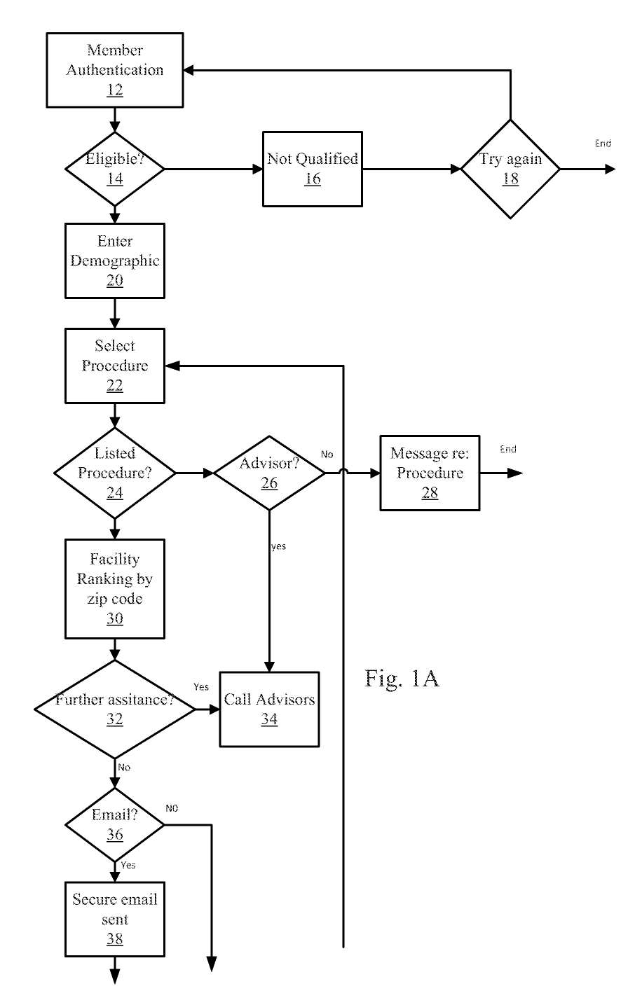

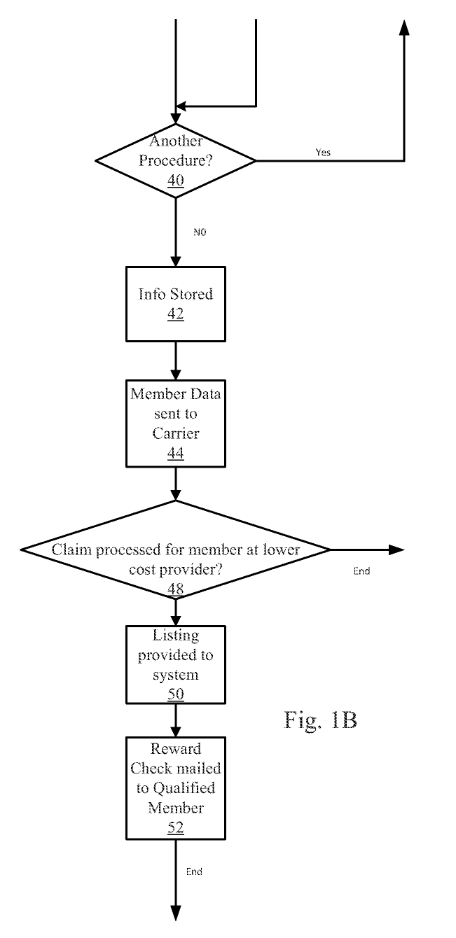

One embodiment of the present invention is illustrated in FIGS. 1A and B. In such an embodiment, the process begins with a Login whereby a member is identified 12 and permitted to proceed. However, one skilled in the art will appreciate that the order of these steps may be changed. In an alternative embodiment, the step of “Selecting a Procedure” and then “being supplied with a Facility Ranking” does not have to be followed by sending the user an email; instead the user may reselect a procedure and be presented with many different rankings.

The method, according to one embodiment of the present invention works as follows: When a member is informed that he/she will need to have a medical procedure they will access the various embodiments of the present invention either by phone or website. This contact can either be established prior to, during or subsequent to the actual provider visit. Once the member authenticates 12 and gains access to the system 14, they will be able to enter basic demographics 20, select a procedure 22 and then be provided with a ranking of facilities/Providers that render this service 30. Once the Facility/Provider cost rankings are provided, the member can choose to have a secure email 36 sent to their attention 38. At this point the selected user information is stored 42 for downstream tracking. If the member seeks care for a selected service, the data stored will be matched against the Insurance Carriers transactional database 44. If the member utilized a lower cost provider during their procedure the provider/facility information will match 48 when provided to the reward administration system 50 and an incentive will be sent to the member 52.

The toolset is designed to allow insurance carrier members the ability to log into a secure site, select a medical procedure and then be supplied with a rank order listing of providers who will deliver the selected service. Additionally, once the procedure is rendered and the lower cost provider chosen, the claim will be matched with the claim processed by the insurance carrier and result in an incentive payment to the member 48, 50. Please refer to the flow drawings below for a key to the reference numbers.

In one embodiment of the present invention, nine steps are utilized to achieve a comparison: member Login; Enter Demographics; Selection of Medical Procedure; Presentation of Facility Ranking; Email to Member; Information Stored; Information to Insurance Carrier; Incentive Listing Confirmed; Incentive Check Issued. Each of these steps is described in detail as follows:

Member Authentication 12—The member will log into a site configured according to an embodiment of the present invention by providing both their Insurance Carrier ID and their first and last name. One skilled in the art will appreciated that other log in procedures may be used, including the use of personal identification numbers, two factor authentication systems, and other secure log ins. If the user is not identified as a member, the system can identify the user as not a qualified member 16. The system may likewise be configured to prompt the user to enter login data a second time 18.

Patient Demographics Entered 20—In some embodiments, listings of procedures may be adjusted based on data in the system like member sex, age, prior conditions, while in other embodiments standard listings and codes may be presented to all users. Demographic data may also be automatically entered upon verified and secure login to the system.

Selection of Medical Procedure 3—The member will be prompted to select 22 from or enter the procedure(s) they are looking to review. At this point in the process, the member can select the procedure in which they are interested. Lists of procedures may be provided 24, Access 26 to a live advisor either by instant messaging, chat, telephone or other means or automated advice system 34 are, in some embodiments offered to users. Messages regarding the procedures may be provided to the user to clarify questions or concerns regarding the ranking system.

Facility Ranking Provided 30—The user is presented with a listing of facilities 30 based upon their geographical location and medical procedure selected. This is rank order listing (from low cost to high) that will provide the facilities name, location and contact information. In some embodiments, the frequency at which a procedure is performed at a provider may be included in the rankings. The user will also be presented with additional instructions as to how to contact their Provider in order to make a change to the lower cost facility. Offers of advice and assistance 32 are provided to the user, and if accepted are routed to the live advisor 34.

Email to the User 36—According to one embodiment of the present invention, at this point, the user will be asked 36 if they would like to have a secure email sent to them that captures in the information they have reviewed and selected for future reference. If they accept, the email is sent as a secure email 38. In either event, the user is then asked if it wishes to view check another procedure 40. If yes, the user is again prompted to select a ne procedure and the system repeats the steps associated with selecting a listed procedure, and ranking facilities on the procedure

Data Stored 42—data from the session is stored for future access by the user, and records of the user's system may be saved for use in incentive programs provided by the insurer.

Information Sent to Insurance Carrier 44—As a result of the information captured on the members using the service, information will be sent to the Insurance Carrier 44 in order for them to match the caller with the service provided. The system tests to see if the user selected the higher ranked provider 48. If is determined that the user selected the lower cost provider, the Insurance Carrier will provide an Incentive file to Incentive administrator the incentive administrator.

Incentives Confirmed 50—Insurance carrier validates data and provides a listing of qualified candidates. 50 This listing is sent back to Incentive administrator the incentive administrator in order to issue incentive checks.

Incentive Checks Issued 52—Based upon the Incentive File received from the Insurance Carrier, incentive checks will be issued to the member (if applicable) based upon the incentive criteria established by their employer. While not all users will be eligible for incentives, such incentives are a means to encourage adoption of the system. Non-monetary incentives may also be provided.

In one embodiment the process begins as one would expect at the Login and ends at issuance of an incentive. However, the order of these steps may be changed. By way of example but not limitation, the step of Selecting a Procedure and then being supplied with a Facility Ranking does not have to be followed by sending the user an email; instead the user may reselect a procedure and be presented with many different rankings.

In one embodiment of the present invention, the method described is executed on an automated system, whereby a user, either accessing the system over worldwide distributed computer network (such as the internet) or by telephone is prompted to enter patient login data, patient demographics, and selection of procedures. Data thus collected is then transferred to the incentive administrator for use in downstream incentive reimbursement. Incentives may likewise be distributed automatically by the system. Such a system may be a computer server system configured to receive input from the user in response to user prompts

In order for facility rankings to be provided 30, a significant amount of data mining, data cleansing and supporting algorithms must be run in order to provide the end user with an understandable and accurate listing of Facilities. These are listed and described in detail below:

1) Selection of Medical Procedures
The Carrier/TPA/Incentive administrator will need to identify the procedures to be utilized within this process. If the overall goal is to drive down medical cost, it is important to consider the following when selecting which procedures to identify:
   The frequency of procedures rendered
   The dollar range difference in reimbursements to providers
   The number of competing providers who render the service within a tight geographical area
Once this has been achieved, all procedures should be identified by the CPT and ICD-9 codes tied to the entire procedure.

2) Supporting Procedure and Code Tables:
The data pulled together in Step 1 will populate the Member Selection Tables that will present themselves to the end user. As described in the flow chart above, this information will allow the end user to select the procedure and then be presented with a listing of facilities in order of cost ranking. Below is an example of a table that would support an end user interaction.

TABLE 2
Procedure and Facility Table:

| Procedure | Codes | Facility | Relative Ranking |
|---|---|---|---|
| Colonoscopy | 45378 | Facility A | 1.000 |
| | | Facility B | 1.656 |
| | 45385 | Facility A | 1.000 |
| | | Facility B | 1.835 |

Please note, the Relative Ranking values will be described in detail:

Once the medical procedures have been selected and CPT codes identified, contract allowed amounts for the medical procedure can be pulled for the corresponding Providers (i.e. Physician, Anesthesiologist, Pathology, Lab, etc.) and Facility either by pulling it directly from the reimbursement contracts or by running data queries against a data warehouse. The method below describes a data mining process in order to render the supporting data for the selection table described above but the process can be shortened by pulling the actual contractual reimbursement amounts directly for the Provider/Facility contracts.

### Example

### Colonoscopy

For this example, let's assume that there are only 2 CPT codes (45378 and 45385) tied to a Colonoscopy and only two facilities (Facility A and Facility B) that offer this service. Contractual Allowed Amounts for each CPT Code should be aggregated by each facility along with the number of procedures rendered for each code. This is accomplished by using either a weighted average or median by provider of care. The information presented in the table 3-A below represents the weighted average approach for your reference:

TABLE 3-A

| | | | | Total Claims | Contractual |
|---|---|---|---|---|---|
| | | | | (Contracted | Allowed Amount |
| | Main CPT | Provider | # of Total | Allowed | Per Main |
| Facility | Code Driver | Type | Procedures | Amount) | Code Driver |
| Facility A | 45378 | Facility | 180 | $126,000.00 | $700.00 |
| | | Physician | 180 | $82,080.00 | $456.00 |
| | | Anesthesia | 162 | $48,600.00 | $300.00 |
| | | Pathology | — | $0.00 | $0.00 |
| | | SubTotal | | $256,680.00 | $1,456.00 |
| Facility A | 45385 | Facility | 220 | $154,000.00 | $700.00 |
| | | Physician | 220 | $154,000.00 | $700.00 |
| | | Anesthesia | 198 | $59,400.00 | $300.00 |
| | | Pathology | 200 | $18,600.00 | $93.00 |
| | | SubTotal | | $386,000.00 | $1,793.00 |
| Facility A - | | Facility | 400 | $280,000.00 | $700.00 |
| Weighted Ave. | | Physician | 400 | $236,080.00 | $590.20 |
| | | Anesthesia | 360 | $108,000.00 | $300.00 |
| | | Pathology | 200 | $18,600.00 | $93.00 |
| | | SubTotal | | $642,680.00 | $1,683.20 |
| Facility B | 45378 | Facility | 215 | $322,500 | $1,500.00 |
| | | Physician | 215 | $98,040 | $456.00 |
| | | Anesthesia | 194 | $87,075 | $450.00 |
| | | Pathology | | $0 | |
| | | SubTotal | | $507,615 | $2,406.00 |
| Facility B | 45385 | Facility | 350 | $630,000 | $1,800.00 |
| | | Physician | 350 | $245,000 | $700.00 |
| | | Anesthesia | 315 | $141,750 | $450.00 |
| | | Pathology | 196 | $78,400 | $400.00 |
| | | SubTotal | | $1,095,150 | $3,350.00 |
| Facility B - | | Facility | 565 | $952,500.00 | $1,685.84 |
| Weighted Ave. | | Physician | 565 | $343,040.00 | $607.15 |
| | | Anesthesia | 509 | $228,825.00 | $450.00 |
| | | Pathology | 196 | $78,400.00 | $400.00 |
| | | SubTotal | | $1,602,765.00 | $3,142.99 |

Based upon the data pulled and the corresponding Contractual Allowed per Procedure Code, it would appear that Facility A with a weighted average of $1,683.20 per colonoscopy procedure is less expensive than Facility B at $3,142.99 or approximately 86% less expensive. However, one must also consider there may be a disproportionate number of complex cases when comparing facilities, therefore it is important to adjust for this by applying the sum total number of procedures by code to all facilities in order to capture an accurate (or case mix adjusted) weighted average amount for each facility. Please note, a median approach could also serve as an appropriate calculation where it would remove any outliers on both the low and high end of the cost spectrum. This can be accomplished applying the statewide total number of procedures by CPT code to the cost developed in the previous exhibit as illustrated below:

TABLE 3-B

| | | | Contractual | | | |
|---|---|---|---|---|---|---|
| | | | Allowed | Total | Total | |
| | | | Amount Per | Statewide | Statewide | |
| | Main CPT | Provider | Main Code | # of | Contractual | |
| Facility | Code Driver | Type | Driver | Procedures | Allowed Amt. | |
| Facility A | 45378 | | | | | |
| | | Facility | $700.00 | 395 | $276,500.00 | |
| | | Physician | $456.00 | 395 | $180,120.00 | |
| | | Anesthesia | $300.00 | 356 | $106,650.00 | |
| | | Pathology | $0.00 | — | | |
| | | SubTotal | $1,456.00 | | $563,270.00 | |
| Facility A | 45385 | | | | | |
| | | Facility | $700.00 | 570 | $399,000.00 | |
| | | Physician | $700.00 | 570 | $399,000.00 | |
| | | Anesthesia | $300.00 | 513 | $153,900.00 | |
| | | Pathology | $93.00 | 396 | $36,828.00 | |
| | | SubTotal | $1,793.00 | | $988,728.00 | |
| Facility A - | | Facility | $700.00 | 965 | $675,500.00 | $700.00 |
| Weighted | | Physician | $590.20 | 965 | $579,120.00 | $600.12 |
| Ave. | | Anesthesia | $300.00 | 869 | $260,550.00 | $300.00 |
| | | Pathology | $93.00 | 396 | $36,828.00 | $93.00 |
| | | SubTotal | $1,683.20 | | $1,551,998.00 | $1,693.12 |
| Facility B | 45378 | | | | | |
| | | Facility | $1,500.00 | 395 | $592,500.00 | |
| | | Physician | $456.00 | 395 | $180,120.00 | |
| | | Anesthesia | $450.00 | 356 | $159,975.00 | |
| | | Pathology | — | — | | |
| | | SubTotal | $2,406.00 | — | $932,595.00 | |
| Facility B | 45385 | | | | | |
| | | Facility | $1,800.00 | 570 | $1,026,000.00 | |
| | | Physician | $700.00 | 570 | $399,000.00 | |
| | | Anesthesia | $450.00 | 513 | $230,850.00 | |
| | | Pathology | $400.00 | 396 | $158,400.00 | |
| | | SubTotal | $3,350.00 | — | $1,814,250.00 | |
| Facility B - | | Facility | $1,685.84 | 965 | $1,618,500.00 | $1,677.20 |
| Weighted | | Physician | $607.15 | 965 | $579,120.00 | $600.12 |
| Ave. | | Anesthesia | $450.00 | 869 | $390,825.00 | $450.00 |
| | | Pathology | $400.00 | 396 | $158,400.00 | $400.00 |
| | | SubTotal | $3,142.99 | — | $2,746,845.00 | $3,127.33 |

As you can see above, the Contractual Allowed Amount per Code is the same as within Table 3-A, however the Case Mix Adjusted Weighted Average Cost for each facility has been adjusted by the case mix to reflect total procedures statewide. This has resulted in slightly reducing the percentage spread difference between the two Facilities but removes any concerns with Case Mix. Again, it is important to note that by pulling actual contract reimbursement amounts directly from the Provider/Facility contracts, data mining to retrieve the Contractual Allowed Amounts would not be necessary.

As a result, the above analysis will provide the factors to complete Table 2 and give the end user with the actual value ranking for the Colonoscopy procedures. This is achieved by pulling the corresponding values from Table 3-B and completing the calculation below:

$$Facility B - ( Code 45378 ) Total Statewide Contractual Amount = Relative Ranking$$

$$Facility A - ( Code 45378 ) Total Statewide Contractual Amount$$

Or with Actual Figures from Table 3-B

$932,595.00/$563,270.00=1.656

This same calculation will be repeated for every code within a defined procedure setting and placed into Table 2 in order to provide a complete Relative Ranking Table.

4) Client Reporting and Member Incentives

The supporting pricing data defined in Step 3 and utilized to populate the Relative Ranking Table in Step 2 will be used to provide both a savings report for the client company and the flag indicator that will support sending an incentive check out to the member when they utilized a lower cost provider.
Savings Report: As a result of the work in Step #3, providing a savings report to a Client can be completed by comparing the Contractual Allowed Amounts by procedure for each facility. The difference in dollars when comparing the member selected facility to the facility they would have selected will represent the actual dollars saved.
Incentive Checks: If the member utilized the lower cost facility as identified within Step 2, supported by Step 3 and matched by the Insurance Carrier's claims data; the member will receive an incentive check.

The invention could be used to provide a consumer with choices regarding a wide range of medical, prescription drug, durable medical, and other ancillary procedure pricing. For example, a member could shop for their prescription drug medications utilizing the same processes as defined above.

The Health Insurance Industry as well as large self-funded employers would be the most likely users of this invention. The method will educate the end consumer by providing much needed cost information for healthcare services.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

We claim:

1. A method for the ranking of health care providers, the method comprising:
identification of a user and logging of said user into a database having user information stored therein;
entering of additional user demographic information necessary for a comparison of health care provider services;
selecting a desired medical procedure for comparison between providers
presenting to said user of a facility ranking for said desired medical procedure based upon quality and cost;
storage of ranking information for future retrieval by said user; and
forwarding said ranking information to an insurance carrier to which the user subscribes.

2. The method according claim 1 further comprising, emailing said ranking information to said user.

3. The method according to claim 1 further comprising confirming an incentive list provided by the insurance carrier.

4. The method according to claim 1 further comprising issuing an incentive to said user for using said method.

5. The method of claim 1 further comprising issuing an incentive payment to a user.

6. The method according to claim 5 wherein said incentive check is issued based on incentive criteria set by an employer of said user.

7. The method of claim 1 further comprising validating said user's qualification for incentives.

8. The method of claim 1 wherein said identification of a user comprises requesting insurance character ID number, and first and last name.

9. The method of claim 1 wherein said facility ranking is ranked according to cost.

10. The method of claim 1 wherein said facility ranking is ranked in order of quality ratings.

11. The method of claim 1 wherein said method is applied to procedures selected based on frequency of procedure, cost, and number of providers within a region.

12. The method of claim 1 wherein said ranking are based on data collected from reimbursement contracts.

13. The method of claim 1 wherein contractual allowed amounts for each procedure and frequency of performance are aggregated by facility.

14. The method of claim 13 wherein said aggregation employs either a weighted average or median by provider.

15. A system for the ranking of health care providers, said system comprising:
a user access portal whereby a user is identified and allowed access to said system;
a medical procedure listing from which said user selects a medical procedure for ranking;
a ranking engine, whereby a rank is generated for health care providers in a geographic region based on weight average costs for said medical procedure;
said rank is provided to said user and is stored for future access by said user;
a reporter, whereby an incentive administrator is informed of said ranking for said user;
incentives issued to said user if said user utilizes said a provider with a ranking indicative of lowest weighted average cost for said region.
